(19) United States
(12) Patent Application Publication
(10) Pub. No.: US 2011/0230171 A1
(43) Pub. Date: Sep. 22, 2011

(54) WIRELESS INTRUSION DETECTION SOLUTION FOR IDLE-MODE CELLULAR DEVICES

(75) Inventor: Mark Edward Kasper, Greenacres, FL (US)

(73) Assignee: 11i Networks Inc., Boca Raton, FL (US)

(21) Appl. No.: 12/474,256

(22) Filed: May 28, 2009

Related U.S. Application Data
(60) Provisional application No. 61/056,800, filed on May 28, 2008.

(51) Int. Cl. H04W 4/00

(52) U.S. Cl. 455/414.1

(57) ABSTRACT

Systems and methods for wireless intrusion detection are described. Small scale wireless systems are configured to transmit commands to cellular devices located within a controlled or secure area. One or more detection systems are configured to identify presence of wireless devices within the controlled area based on a radio frequency (RF) transmission of the wireless devices in response to the commands. The microcellular wireless system operates independently of a provider of wireless service to the detected wireless device. The detection system can identify location of the detected wireless device within the controlled area.

### CROSS-REFERENCE TO RELATED APPLICATIONS

The present Application claims priority from U.S. Provisional Patent Application No. 61/056,800 filed May 28, 2008, entitled “Wireless Intrusion Detection Solution For Idle-Mode Cellular Devices,” which is expressly incorporated by reference herein for all purposes.

### BACKGROUND OF THE INVENTION

1. Field of the Invention

The present invention relates generally to intrusion detection in cellular networks.

2. Description of Related Art

Enforcement of no-cell phone policies and restrictions on use of cellular devices can be problematic. Cellular devices can be difficult to detect particularly where detection areas offer a brief detection window. For example, at secure entry points, the time it takes for people to transit the detection point, and even the building, could be as short as 20-30 seconds. Current cellular wireless intrusion detection systems will not detect a large percentage of cellular devices in this scenario. Since idle-mode cellular devices are not transmitting on the uplink, they are “undetectable” to commercially available cellular wireless intrusion detection systems.

As illustrated in FIG. 1, commercially available cellular wireless intrusion detection systems 14 rely on network traffic between cell tower 10 and device 12. Specifically, detection system 14 works by detecting uplink radio frequency (“RF”) activity transmitted from cellular wireless device 12 to cell tower 10. However, when cellular wireless device 12, such as a cell phone is in idle-mode, it not transmitting on the uplink and becomes undetectable. Cellular wireless intrusion detection solutions on the market today fall short with regard to detecting idle-mode cell phones because idle-mode cellular devices do not transmit on the uplink and are consequently undetectable to cellular wireless intrusion detection systems.

### BRIEF SUMMARY OF THE INVENTION

Aspects of the present invention enable rapid detection and location of a high percentage of idle-mode cellular devices in areas that have a brief detection window, thereby permitting, for example, enforcement of no cell phone policy for idle-mode cell phones. Certain embodiments of the invention provide alternatives to jamming technology, comply with federal, state and other law. Embodiments of the invention need not affect normal cell phone operation. Embodiments of the invention may be deployed in low-cost, highly-configurable configurations with small RF footprint using directional antennas and power control.

In certain embodiments, small scale wireless systems are deployed and configured to transmit commands to cellular devices located within a controlled or secure area. One or more detection systems are deployed and configured to identify presence of wireless devices within the controlled area based on a radio frequency (RF) transmission of the wireless devices in response to the commands. The microcellular wireless system operates independently of a provider of wireless service to the detected wireless device. The detection system can identify location of the detected wireless device within the controlled area.

### BRIEF DESCRIPTION OF THE DRAWINGS

FIG. 1 illustrates prior art cellular phone detection systems.

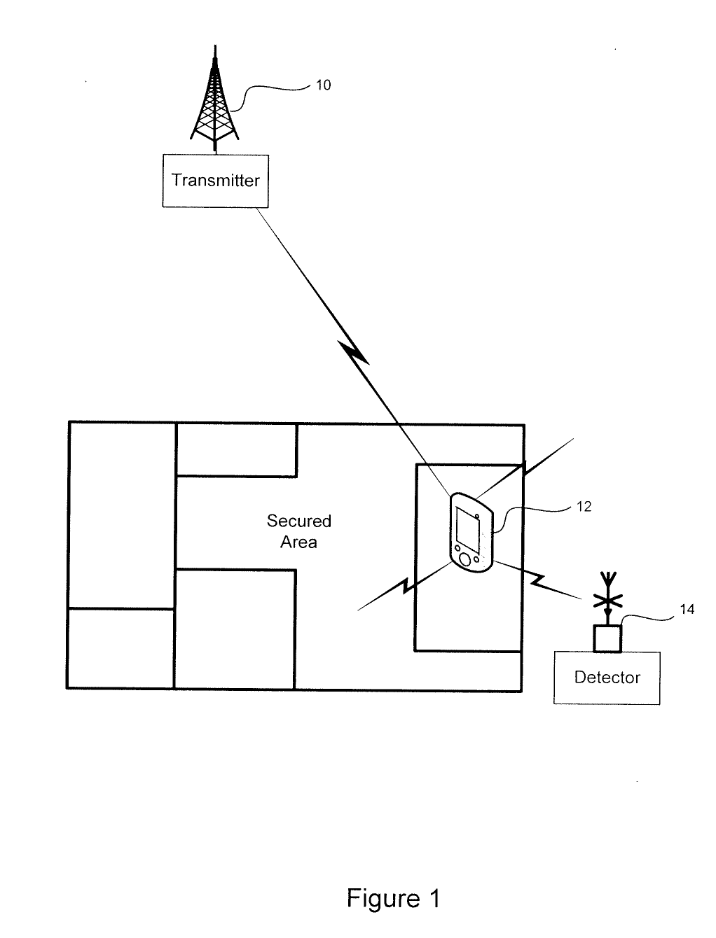

FIG. 2 shows an example of an intrusion detection system according to certain aspects of the present invention.

FIG. 3 shows a variation on the example of FIG. 2.

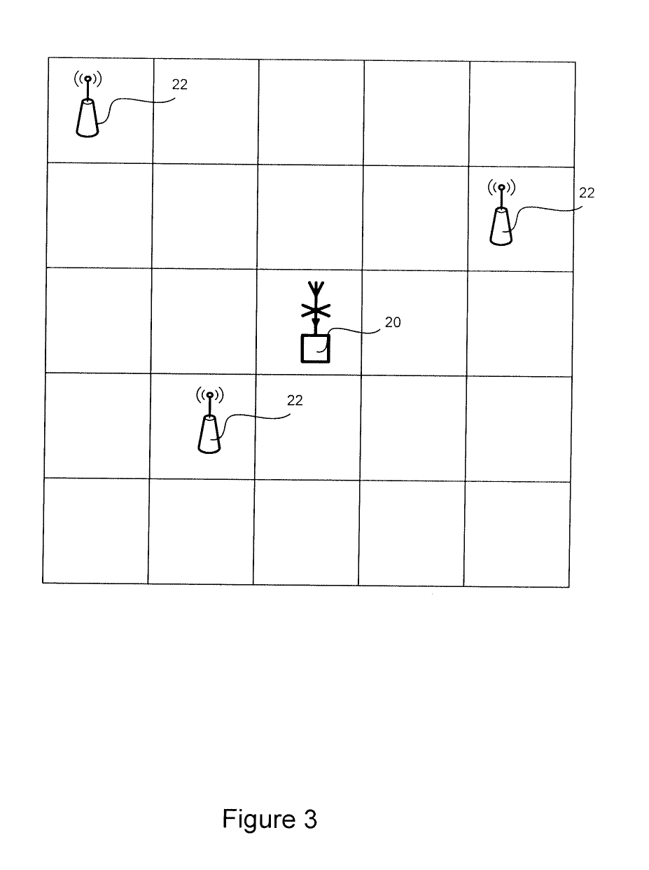

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention may be deployed to enforce cell phone exclusion policies in areas that have a brief detection window. For example, a brief detection window may be observed at secure entry points where the time it takes for people to transit a building can often be as short as 20-30 seconds. Aspects of the present invention permit the detection of all or substantially all cellular devices. In some embodiments idle-mode cell phones can be triggered to reveal themselves to a cellular wireless intrusion detection system resulting in significantly fewer cellular phone security breaches.

Various detection systems used to detect and track cellular wireless devices, such as cellular phones can be incorporated into embodiments of the invention including detection systems based on “time of arrival” and “power triangulation.” In both of these examples, detection and tracking techniques are based upon RF signals transmitted from the cellular device. Time of arrival is typically used by cellular carriers such as T-Mobile and AT&T Wireless to support E911 Phase II location identification requirements. Power triangulation is the technique most commonly used in commercially available cellular wireless intrusion detection systems.

For the purposes of this description, “uplink” communication refers to RF messages that are sent from a cellular device to a cellular network. Transmissions from a cellular device are typically received at a carrier's cellular antenna tower. RF messages sent from a carrier's cellular antenna tower to a cellular device will be referred to as “downlink” messages. For example, when a cell phone is switched on or off, or when a call is received or placed, the cell phone communicates with the cellular network via RF energy transmitted from the cellular phone. Uplink signals transmitted by a cellular wireless device can be used as the basis for detecting and locating the cellular wireless device. Accordingly, it will be appreciated that a cell phone must typically do something on the uplink (i.e. transmit something) in order to be detected and located.

For the purposes of this description, a cellular device is considered to be in “idle mode” when the cellular device is powered on but is not transmitting on the uplink. Thus, idle-mode can be considered to be a state in which RF energy is not transmitted by the cellular device. It is contemplated that aspects of the present invention take into consideration other forms of RF transmission from the cellular device. For example, RF signals associated with WiFi, Bluetooth and other networks may be detectable by suitably equipped receivers.

A cellular phone typically remains in idle mode until one or more events occur. These events include power on or power off, a location update activity, expiration of a paging timer, a paging request including outgoing and incoming paging activity, placement or receipt of a call or other call setup request or command, a request to transmit an SMS, MMS or a messaging event or command, receipt of an SMS, MMS or other message and any other data communication between the cellular device and a cellular network.

Certain embodiments of the invention can rapidly detect and locate a high percentage of idle-mode cellular phones in locations that have a brief detection window. Certain embodiments of the invention permit enforcement of no cell phone policy for idle-mode cell phones. A desired secure coverage area can be predefined and may be configurable based on application requirements. Typically, jamming technology is not used and integration with existing local cellular Planned Land Mobile Networks (PLMN) is not required. Aspects of the present invention perform the desired functions without violating laws and regulations and without interfering with other wireless networks or prevention of normal cellular wireless functionality.

Certain embodiments of the invention may be configured based on regulatory compliance and security needs. Embodiments of the invention provide be relatively low-cost solutions that require minimal training and support. Certain embodiments support monitoring and operation by remote, often centralized surveillance and control centers. Certain embodiments provide a reporting function and audit trails that can be maintained in one or more databases, including databases used for forensics records.

In certain embodiments, idle-mode cell phones are triggered to perform some function on the uplink as they enter and pass through a secure area. Typically, uplink functions are based on interactions and/or events to and from a PLMN cellular wireless system. A small-scale cellular wireless system may be used to simulate a PLMN cellular wireless network of a carrier such as T-Mobile, AT&T, Sprint, Verizon and Telus. In certain embodiments, commercially available small-scale solutions may be adapted for this purpose; for example a test system for cellular devices may include such small-scale solution.

Certain embodiments employ adapted microcellular networks. Microcellular networks include low-cost, software-based, configurable cellular wireless systems. Examples of microcellular networks include a ship-board cellular system that is installed on cruise ships and rapidly-deployable mobile networks used for disaster recovery.

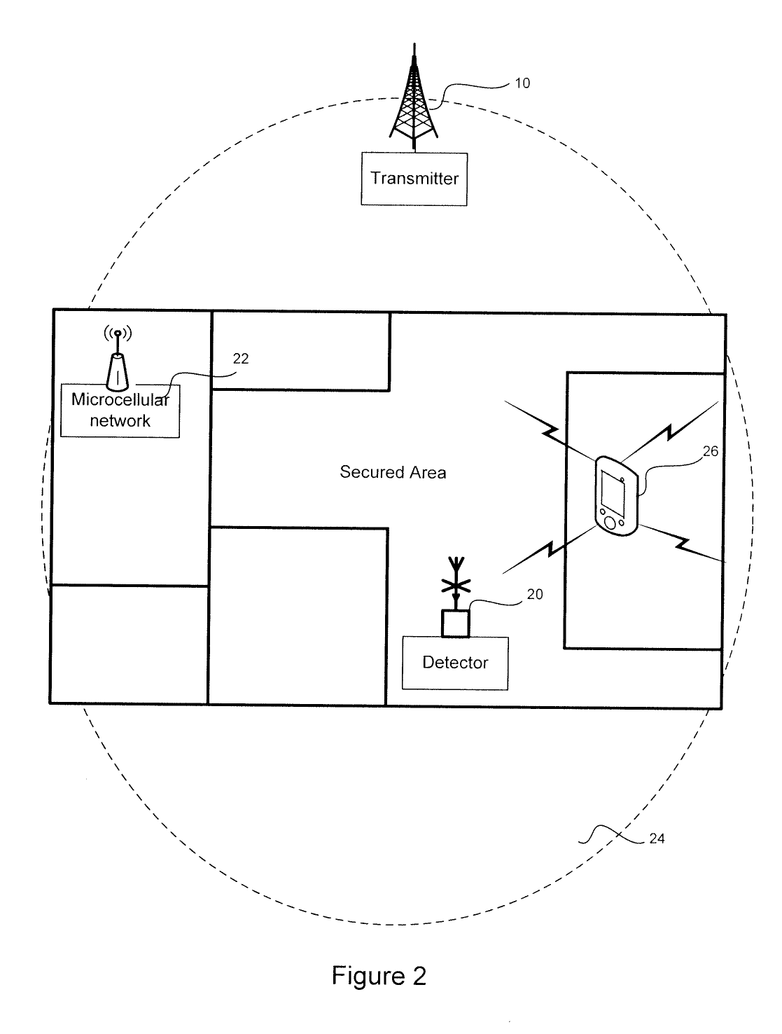

Turning now to FIG. 2, certain embodiments of the invention comprise a cellular wireless intrusion detection system 20, and a microcellular wireless system 22. Microcellular wireless system 22 is typically installed in or adjacent to a secure area and may be adapted and configured according to certain aspects of the invention. The microcellular wireless system 22 can be configured to simulate downlink messages originating from a carrier PLMN network 24. The microcellular wireless system 22 may, for example, send downlink messages to an idle-mode cellular device 26 that are calculated to trigger the cellular device 26 such that the device 26 performs some function requiring an uplink transmission. When an idle-mode device 26 communicates with the microcellular wireless system 22 on the uplink, cellular wireless intrusion detection system 20 can detect and locate the phone.

It will be appreciated that cellular wireless intrusion detection system 20 is typically installed in the same general area as microcellular system 22 and covers the same cellular wireless detection area. However, it is contemplated that variations in this configuration may be desirable. In one variation, a single cellular wireless detection system 20 may be used with plural microcellular wireless systems 22. The single wireless detection system 20 may be configured to distinguish between responses from devices such as wireless device 26 elicited by different microcellular wireless systems 22. For example, the different microcellular wireless systems 22 may use different triggers at different times, may use different signaling schemes or may be centrally controlled and synchronized with the wireless detection system 20. In this manner, surveillance of geographically distinct areas may be performed and/or adjacent areas (such as floors on a building) may be controlled using relatively low power microcellular wireless systems 22. In the latter example, the detection system 20 may obtain additional location information related to a single cellular device 26 based on response of the device 26 to one or more of the microcellular wireless systems 22.

In another variation, a single microcellular wireless system 22 may be used to cover multiple areas, each of the multiple areas being monitored by a wireless detection system 20.

In certain embodiments, microcellular wireless system 22 is configured to ensure that cell devices 26 that move into the coverage area of the microcellular wireless system 22 are forced to transmit RF energy. In one example, the microcellular wireless system 22 may send paging requests that force devices 26, such as cell phones, to transmit a paging response. The timing of the transmissions by microcellular wireless system 22 may be selected based on the area to be covered. For example, the timing may be selected to ensure that a paging request is sent by the microcellular wireless system 22 within the minimum time that the cellular device 26 resides within the coverage area.

In certain embodiments changes made by the carrier to parameters that affect subscriber cellular devices 26 are reflected in the configuration of microcellular system 22. Microcellular system 22 adapts to such carrier changes in order to send downlink messages that will be accepted by the cellular devices 26 and thereby trigger an idle-mode cell phone 26 to perform some function on the uplink. Thus, parameters of the micro-cellular system 22 in many embodiments are automatically reconfigured to match relevant parameters in the local cellular wireless PLMN. Whenever a local carrier changes parameters, the microcellular system 22 is also reconfigured to match the local carrier's configuration.

In certain embodiments, parameters within the microcellular system 22 are synchronized with relevant parameter settings used in the local carrier's PLMN configuration whenever changes are made to relevant parameters in the local carrier's PLMN configuration. These embodiments may comprise a monitoring system that can detect and translate cellular wireless network parameter configurations, a configurable scheduling process on the monitoring system that governs the time periods in which the monitoring system is monitoring, a parameter passing process that passes parameters from the monitoring process to a software configuration command generator and a configuration command generator that reads in the parameters and then creates configuration commands understandable to the microcellular system.

Certain embodiments comprise a command passing process that passes the configuration commands from the command generator to an interface between the monitoring system/command generator and the microcellular system, a command receiver process on the microcellular system 22 that receives the commands from the command generator via the interface and a configurable scheduling & execution process on the micro-cellular system that governs the execution of the software configuration commands received from the command generator.

In certain embodiment, a method for synchronizing parameters includes causing a scheduling process on the monitoring system to activate the monitor process. The monitor process may read the relevant cellular wireless network parameter settings and pass control to the parameter passing process, which sends the parameters to the configuration command generator. The configuration command generator may generate commands for reconfiguring hardware and/or software components of the system. The configuration command generator receives the parameters from the parameter passing process and then generates configuration commands that are executable by a combination of hardware and software in the microcellular system 22

The command generator sends the commands to the command passing process, which passes the commands to the interface process. A command receiver process on the micro-cellular system typically receives the commands from the interface and causes the commands to be scheduled and/or executed, typically by an execution process that schedules and executes the configuration commands created by the configuration command generator.

In certain embodiments, intrusion detection is managed centrally. For example, a plurality of microcellular systems 22 and intrusion detectors 20 may be controlled and configured at a central control station. Commands transmitted by each of the microcellular systems 22 can be scheduled and synchronized to maximize information obtained from responses transmitted by cellular devices within a controlled and/or secured area. For example, power levels of microcellular systems can be controlled to obtain a desired pattern of coverage. In another example, the transmission of commands by the microcellular systems 22 can be coordinated and scheduled such that arrival of responses at one or more detectors can be used to calculate location of a cellular device. It is contemplated that, in certain embodiments, functions of microcellular system 22 and detectors 20 can be collocated and/or combined into a single device.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Aspects of the present invention enable rapid detection and location of a high percentage of idle-mode cellular devices in areas that have a brief detection window, thereby permitting, for example, enforcement of no cell phone policy for idle-mode cell phones. Certain embodiments of the invention provide alternatives to jamming technology, comply with federal, state and other law. Embodiments of the invention need not affect normal cell phone operation. Embodiments of the invention may be deployed in low-cost, highly-configurable configurations with small RF footprint using directional antennas and power control.

Certain embodiments of the invention provide a wireless intrusion detection system for cellular devices. Some of these embodiments comprise a small scale wireless system deployed and configured to transmit commands to cellular devices located within a controlled area. Some of these embodiments comprise a detection system deployed and configured to identify presence of wireless devices within the controlled area based on a radio frequency (RF) transmission of the wireless devices. In some of these embodiments, a wireless device is detected when it transmits a response to one or more of the commands. In some of these embodiments, the microcellular wireless system operates independently of a provider of wireless service to the detected wireless device. In some of these embodiments, the wireless service is a planned land mobile network (PLMN) service.

In some of these embodiments, the detection system further identifies location of the detected wireless device within the controlled area. In some of these embodiments, the system comprises a plurality of detection systems configured to identify presence of wireless devices. In some of these embodiments, the location of the detected wireless device is identified by time of arrival at one or more of the plurality of detection systems. In some of these embodiments, the location of the detected wireless device is identified by power triangulation. In some of these embodiments, the small scale wireless system is a microcellular system.

In some of these embodiments, parameters of the microcellular system are synchronized with corresponding parameter settings associated with the PLMN service. In some of these embodiments, the wireless device is a cellular telephone. In some of these embodiments, the commands include a user generated command. In some of these embodiments, the user generated command comprises a call set up request. In some of these embodiments, the commands include a messaging command. In some of these embodiments, the commands include a paging request. In some of these embodiments, the commands are transmitted according to a schedule calculated based on the size of the controlled area.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A wireless intrusion detection system for cellular devices, comprising:
a small scale wireless system configured to transmit commands to cellular devices located within a controlled area;
a detection system configured to identify presence of wireless devices within the controlled area based on a radio frequency (RF) transmission of the wireless devices, wherein a wireless device is detected when it transmits a response to one or more of the commands, and wherein the microcellular wireless system operates independently of a provider of wireless service to the detected wireless device.

2. The system of claim 1, wherein the wireless service is a planned land mobile network (PLMN) service.

3. The system of claim 2, wherein the detection system further identifies location of the detected wireless device within the controlled area.

4. The system of claim 3, wherein the system comprises a plurality of detection systems configured to identify presence of wireless devices.

5. The system of claim 4, wherein the location of the detected wireless device is identified by time of arrival at one or more of the plurality of detection systems.

6. The system of claim 4, wherein the location of the detected wireless device is identified by power triangulation.

7. The system of claim 2, wherein the small scale wireless system is a microcellular system.

8. The system of claim 7, wherein parameters of the microcellular system are synchronized with corresponding parameter settings associated with the PLMN service.

9. The system of claim 3, wherein the wireless device is a cellular telephone.

10. The system of claim 9, wherein the commands include a user generated command.

11. The system of claim 10, wherein the user generated command comprises a call set up request.

12. The system of claim 10, wherein the commands include a messaging command.

13. The system of claim 9, wherein the commands include a paging request.

14. The system of claim 2, wherein the commands are transmitted according to a schedule calculated based on the size of the controlled area.
